(19) United States
(12) Patent Application Publication
(10) Pub. No.: US 2013/0098325 A1
(43) Pub. Date: Apr. 25, 2013

(54) AIR SUPPLY DEVICE FOR 2 STROKE ENGINE

(71) Applicants: Yoshinori Fukushima, Saitama (JP); Hiroyuki Noda, Saitama (JP)

(72) Inventors: Yoshinori Fukushima, Saitama (JP); Hiroyuki Noda, Saitama (JP)

(73) Assignee: HUSQVARNA ZENOAH CO., LTD., Saitama (JP)

(21) Appl. No.: 13/805,797

(22) PCT Filed: Oct. 13, 2010
(86) PCT No.: PCT/JP2010/006096

§ 371 Date: Dec. 20, 2012

(30) Foreign Application Priority Data
Jun. 28, 2010 (JP) PCT/JP2010/004276

(51) Int. Cl. F02M 35/10

(52) U.S. Cl. CPC F02M 35/10
USPC 123/184.23

(57) ABSTRACT

An air supply device (2) used in a two-stroke engine includes: an insulator (14) having an insulator mixture passage (17) that is in communication with an intake port (5A) provided in an engine body (1) of the two-stroke engine, the insulator being attached to the engine body (1); a carburetor (15) having an insulator mixture passage (17) that is in communication with an insulator mixture passage (17), the carburetor (15) being attached to the insulator (14); an air cleaner (16) having a mixture-side opening (25) that is in communication with the carburetor mixture passage (19), the air cleaner (16) being attached to the carburetor (15); an accumulating portion (29) that accumulates a blow-back fuel returned through the mixture-side opening 25, the accumulating portion (29) being provided inside the air cleaner (16); and an auxiliary passage having a base end connected to the accumulating portion (29) and a distal end connected to a portion affected by a pressure fluctuation inside a crankcase chamber provided in the engine body (1).

### TECHNICAL FIELD

The present invention relates to an air supply device for a two-stroke engine and especially relates to an air supply device having an arrangement suitable for utilizing blow-back fuel.

### BACKGROUND ART

Two-stroke combustion engines are well known in the art. In two-stroke combustion engines, a complete cycle of the engine includes an upward stroke and a downward stroke of a piston. During an upward stroke, intake of fresh air-fuel takes place whereas, during a subsequent downward stroke after ignition, scavenging occurs. During the downward stroke, a part of fuel or air-fuel mixture may flow in a direction away from the engine from a carburetor and enter an air cleaner. The fuel that enter the air cleaner is generally referred to as blow-back fuel. Blow-back fuel results in loss of fuel and also clog filter elements in the air cleaner.

Various measures have been adopted in the art to reduce the blow-back fuel. One way is to provide a preventive plate in the air cleaner to prevent a flow of the blow-back fuel from the carburetor into the filter element such that the blow-back fuel is securely reused in the next upward stroke of the piston.

Another commonly known measure is to improve a structure of a piston reed valve.

### SUMMARY OF INVENTION

### Technical Problem

However, when a preventive plate is provided, the intake of the air is impeded to cause an intake resistance according to the size of the preventive plate, thereby reducing an output of the two-stroke engine.

Further, in order to improve the structure of the piston reed valve, the structure of the piston reed valve may become more complicated and expensive. Moreover, such a structure may also be susceptible to failures.

In light of the foregoing, an object of the invention is to provide an air supply device for a two-stroke combustion engine to use the blow-back fuel without waste and without involving a complicated construction or decreasing the output of the two-stroke combustion engine.

### Solution to Problem

An air supply device according to an aspect of the invention is used for a two-stroke engine, the air supply device including: an insulator having an insulator mixture passage that is in communication with an intake port provided on an engine body of the two-stroke engine, the insulator being attached to the engine body; a carburetor having a carburetor mixture passage that is in communication with the insulator mixture passage, the carburetor being attached to the insulator; an air cleaner having a mixture-side opening that is in communication with the carburetor mixture passage, the air cleaner being attached to the carburetor; an accumulating portion provided inside the air cleaner, the accumulating portion accumulating a blow-back fuel returned from the mixture-side opening; and an auxiliary passage having a base end connected to the accumulating portion and a distal end connected to a portion affected by a pressure fluctuation inside a crankcase chamber provided to the engine body.

Examples of the “portion affected by a pressure fluctuation inside a crankcase chamber” include: the crankcase chamber itself; a cylinder chamber provided in the engine body; the carburetor mixture passage of the carburetor; the insulator mixture passage of the insulator; a gap provided between opposing surfaces of the carburetor and the air cleaner; and the mixture-side opening.

According to the above aspect of the invention, since the accumulating portion provided in the air cleaner and the portion affected by the pressure inside the crankcase chamber are connected by the auxiliary passage, the blow-back fuel accumulated in the air cleaner can be sucked into the engine body through the auxiliary passage, thereby efficiently using the blow-back fuel without waste. Further, since the blow-back fuel accumulated at the accumulating portion is securely used, less amount of blow-back fuel is to be trapped by a conventional preventive plate. Thus, no large preventive plate is necessary so that the increase in the intake resistance can be prevented, thereby favorably maintaining the engine performance.

In the air supply device according to the above aspect of the invention, the auxiliary passage is preferably provided within the air cleaner when a distal end of the auxiliary passage is connected to a gap between the air cleaner and the carburetor or when the distal end of the auxiliary passage is connected to the mixture-side opening of the air cleaner itself.

With this arrangement, since it is not necessary to expose the auxiliary passage to the outside, the structure can be simplified. In addition, since the auxiliary passage is insusceptible to the influence of the heat from the engine body, the durability of the auxiliary passage can be improved. Further, since the length of the auxiliary passage can be reduced, the pressure loss in the auxiliary passage can be reduced, so that the pressure difference between the accumulating portion and the portion to be connected can be sufficiently effected, thereby securely sucking the blow-back fuel at the accumulating portion.

In the air supply device according to the above aspect of the invention, the auxiliary passage is preferably provided by a pipe.

According to the above arrangement, the accumulating portion and the portion to be connected can be easily connected. Further, since design alteration is facilitated, the portion to be connected can be selected from various portions such as the crankcase chamber and the insulator mixture passage, thereby enhancing the design freedom.

In the air supply device according to the above aspect of the invention, at least a part of the auxiliary passage is preferably covered by an insulating material. Especially, when the auxiliary passage is provided by a pipe and the like and is exposed to an outside, covering the necessary portions with an insulating material so as not to be influenced by the heat from the heated portion of the engine body is effective for improving the durability.

In the air supply device according to the above aspect of the invention, the accumulating portion is preferably provided at a position at which the blow-back fuel from the mixture-side opening drips to be accumulated.

According to the above arrangement, since the accumulating portion can be provided at the portion at which the blow-back fuel drips by virtue of gravity, a complicated guide mechanism for introducing the blow-back fuel to the accumulating portion is not necessary, thereby further simplifying the structure.

In the air supply device according to the above aspect of the invention, the air supply device is preferably applied to a piston-valve two stroke engine in which the intake port is opened and closed by a piston.

Since the piston-valve engine tends to produce more blow-back fuel as compared a reed-valve engine, the advantages of the invention can be eminently and effectively exhibited when the air supply device of the invention is applied to the piston-valve engine in order to efficiently use the blow-back fuel.

In an air supply device according to an aspect of the invention, it is desirable that the air supply device includes a choke plate capable of opening/closing the mixture-side aperture, in which the choke plate is provided with an auxiliary passage formation portion that forms at least a part of the auxiliary passage when the choke plate is positioned to open the mixture-side aperture.

In the above aspect of the invention, when the mixture-side aperture is closed by the choke plate, an auxiliary passage is not formed. In contrast, when the mixture-side aperture is not closed and is opened into an air cleaner body, the auxiliary passage is formed by the auxiliary passage formation portion of the choke plate, whereby the blow-back fuel can be returned via the auxiliary passage. Accordingly, when a choke is working, negative pressure in the crankcase chamber does not work on the accumulating portion, but favorably works on a carburetor to reliably effect the choke.

In the air supply device according to the aspect of the invention, it is desirable that the auxiliary passage includes: a first passage groove of which one end is communicated with the accumulating portion, the first passage groove being provided on a surface of the air cleaner body; a second passage groove of which one end is communicated with the mixture-side aperture, the second passage groove being provided on the surface of the air cleaner body; and the auxiliary passage formation portion, in which the auxiliary passage formation portion is provided by a part of a surface of the choke plate that faces and covers the first and second passage grooves, and a connecting groove that communicates the other ends of the first and second passage grooves with each other.

In the above aspect of the invention, when the choke plate is moved to open the mixture-side aperture, the first and second passage grooves are connected to each other via a connecting groove to form the auxiliary passage. Accordingly, the blow-back fuel accumulated in the accumulating portion is reliably returnable to the mixture-side aperture via the auxiliary passage.

In the air supply device according to the aspect of the invention, it is desirable that the second passage groove is closed by the choke plate when the choke plate is positioned to close the mixture-side aperture.

With this arrangement, when the mixture-side aperture is closed by the choke plate, the second passage groove is similarly closed by the choke plate. Accordingly, when the choke is working, air does not flow in from the second passage groove, whereby the choke can be reliably effected.

In the air supply device according to the aspect of the invention, it is desirable that the auxiliary passage includes: a connecting groove of which one end is communicated with the accumulating portion and the other end is communicated with the mixture-side aperture; and the auxiliary passage formation portion, and the auxiliary passage formation portion is a part of a surface of the choke plate that faces and covers the connecting groove.

With this arrangement, since a continuous connecting groove is provided on the air cleaner body, the blow-back fuel can smoothly flow in the connecting groove (auxiliary passage).

In the air supply device according to the aspect of the invention, it is desirable that the auxiliary passage is provided by a conduit that penetrates a thick portion of the choke plate to communicate the accumulating portion and the mixture-side aperture with each other.

With this arrangement, the auxiliary passage is provided by a conduit and a circumference of the auxiliary passage is completely covered. Accordingly, the negative pressure in the crankcase chamber can reliably work on the accumulating portion with less leakage, whereby the blow-back fuel can be favorably returned.

In the air supply device according to the aspect of the invention, it is desirable that the air cleaner body includes a pair of lock portions corresponding to the open/closed positions of the mixture-side aperture by the choke plate, and the choke plate includes a retaining portion that is engaged with the lock portion.

This arrangement prevents the choke plate from being displaced from the open/closed position because of vibration of the engine or other parts. The displacement of the choke plate may prevent an operation of the engine. For instance, when the choke plate is displaced from the open position to the closed position, an air supply to the engine may be stopped to stop the engine during an operation.

In the air supply device according to the aspect of the invention, it is desirable that the pair of lock portions is provided near ends of a curved rib along an open/closed trajectory of the choke plate, and the curved rib serves as a guiding portion that guides the blow-back fuel from the mixture-side aperture toward the accumulating portion, an upper end of the curved rib being positioned near the mixture-side aperture and a lower end of the curved rib being positioned near the accumulating portion.

With this arrangement, the blow-back fuel from the mixture-side aperture can be more reliably guided downward to the accumulating portion by the guiding portion formed by the curved rib, so that the blow-back fuel can be favorably returned from the accumulating portion.

### BRIEF DESCRIPTION OF DRAWINGS

FIG. 1 is a cross section showing an engine installed with an air supply device according to a first exemplary embodiment of the invention.

FIG. 2 is a cross section showing an engine installed with an air supply device according to a second exemplary embodiment of the invention.

FIG. 3 is a cross section showing an engine installed with an air supply device according to a third exemplary embodiment of the invention.

FIG. 4 is a cross section showing an engine installed with an air supply device according to a fourth exemplary embodiment of the invention.

FIG. 5 is a cross section showing an engine installed with an air supply device according to a fifth exemplary embodiment of the invention.

FIG. 6 is a cross section showing an engine installed with an air supply device according to a sixth exemplary embodiment of the invention.

FIG. 7 illustrates a sectional view of a two-stroke combustion engine with an air supply device, according to a seventh exemplary embodiment of the present invention.

FIG. 8A illustrates a front view of the air cleaner with a choke plate in a closed position, according to the seventh exemplary embodiment of the present invention.

FIG. 8B illustrates a front view of the air cleaner with the choke plate in an open position, according to the seventh exemplary embodiment of the present invention.

FIG. 9A illustrates a rear view of the choke plate, according to the seventh exemplary embodiment of the present invention.

FIG. 9B illustrates a sectional view of the choke plate along an axis A-A′ in FIG. 9A.

FIG. 10 illustrates a front view of the air cleaner with a single auxiliary passage, according to an eighth exemplary embodiment of the present invention.

FIG. 11A illustrates a front view of the air cleaner with an auxiliary passage included in the choke plate, according to a ninth exemplary embodiment of the present invention.

FIG. 11B illustrates a sectional view of the air cleaner taken along an axis B-B′ in FIG. 11A.

### DESCRIPTION OF EMBODIMENTS

### First Exemplary Embodiment

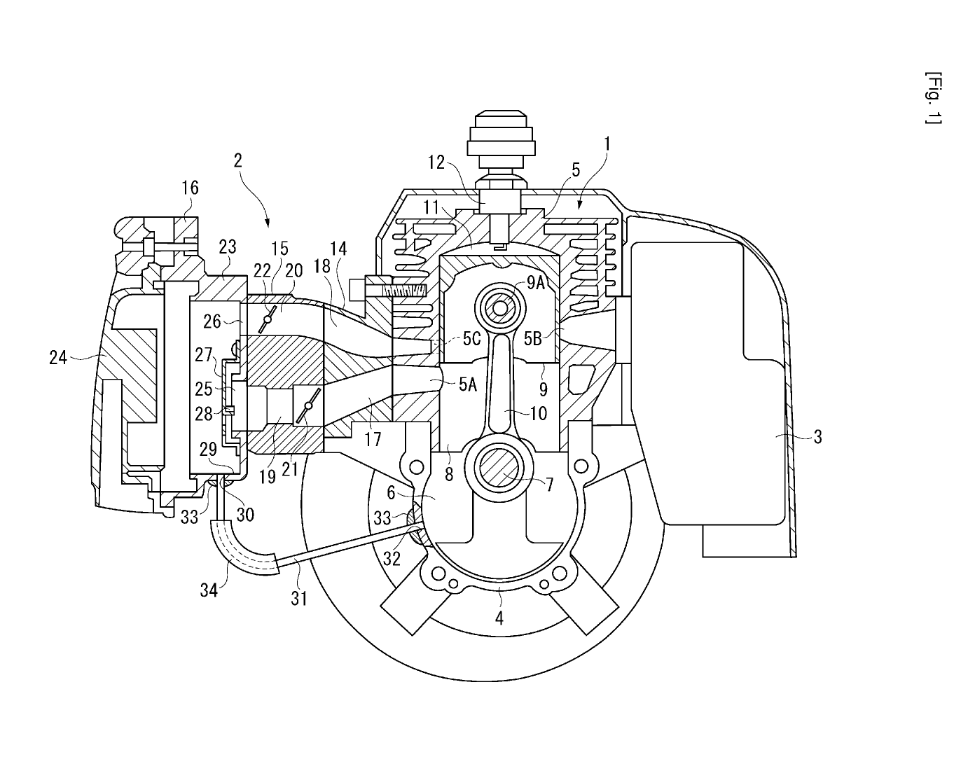

A first exemplary embodiment of the invention will be described below with reference to FIG. 1. Incidentally, the same reference numeral will be used in below-described the second and subsequent exemplary embodiments for the same components as those in the first exemplary embodiment to omit or simplify the description thereof in the second and subsequent exemplary embodiments.

As shown in FIG. 1, a two-stroke engine (will be simply referred to as an engine hereinafter) according to this exemplary embodiment includes: an engine body 1; an air supply device 2 provided on an intake side of the engine body 1; and an exhaust muffler 3 provided on an exhaust side of the engine body 1.

The engine body 1 includes a crankcase 4 and a cylinder 5 attached to an upper part of the crankcase 4. A crank shaft 7 is rotatably supported in a crankcase chamber 6 provided in the crankcase 4. A piston 9 is slidably housed within a cylinder chamber 8 provided in the cylinder 5. A piston pin 9A of the piston 9 and the crank shaft 7 are connected by a connecting rod 10.

The crankcase 4 of this exemplary embodiment is provided by a pair of case components (i.e. dual-divided). The respective case components are mutually connected along an axial direction of the crank shaft 7. One of the case components is illustrated in FIG. 1. However, the crankcase 4 may be provided by another dual-divided structure in which the crank shaft 7 is vertically (in the drawing) held. The crankcase chamber 6 of the crank case 4 is communicated with the cylinder chamber 8 at a lower part of the piston 9.

An intake port 5A for drawing the air-fuel mixture is provided on a cylinder wall of the cylinder 5 on a side at which the air supply device 2 is attached. An exhaust port 5B for exhausting exhaust gas is provided on the cylinder wall on a side at which the exhaust muffler 3 is attached.

Further, though not illustrated, a transfer passage for communicating the crankcase chamber 6 with a combustion chamber 11 above the piston 9 is provided in the cylinder wall. An upper end of the transfer chamber is opened at the combustion chamber 11 as a transfer port.

Further, the engine according to this exemplary embodiment is a stratified scavenging engine. Accordingly, an air port 5C for drawing fresh air is provided on an upper side of the intake port 5A of the cylinder wall. The air port 5C is biforked to be opened at two positions to the combustion chamber 11. In the last stage of the upward stroke of the piston 9, the air port 5C is in communication with a recessed communication groove (not shown) provided on an outer circumference of the piston 9 to be in communication with the transfer port.

The piston 9 serves as a piston valve for opening/closing the intake port 5A, the exhaust port 5B, the air port 5C and the transfer port. Specifically, in the last stage of an upward stroke (shown in FIG. 1), the piston 9 opens the intake port 5A and the air port 5C. Accordingly, on account of a negative pressure in the crankcase chamber 6, a fresh air-fuel mixture is drawn from the air supply device 2 to be filled in the crankcase chamber 6 through a lower side of the cylinder chamber 8.

At the same time, fresh air from the air supply device 2 is drawn from the air port 5C. Then, the fresh air is filled to an upper side (a side near the transfer port) of the transfer passage through the communication groove of the piston 9 from the transfer port.

When combustion takes place within the combustion chamber 11 by ignition of a spark plug 12 to turn the stroke of the piston 9 downward, the piston 9 opens the exhaust port 5B while closing the air port 5C and the intake port 5A.

By opening the combustion chamber 11 by the exhaust port 5B and pressurizing the interior of the crankcase chamber 6 by the downward stroke of the piston 9, the air-fuel mixture within the crankcase chamber 6 is supplied to the combustion chamber 11 through the transfer passage and simultaneously scavenges combustion gas within the combustion chamber 11 to exhaust the combustion gas from the exhaust port 5B as the exhaust gas.

At this time, since the fresh air is filled in the transfer passage near the transfer port, when the combustion gas is scavenged, the fresh air initially works as lead air for scavenging the combustion gas. Accordingly, during the scavenging process, unburned fuel contained in the air-fuel mixture is unlikely to be blown off through the exhaust port 5B, thereby reducing the emission.

Incidentally, in a two-stroke engine, air-fuel mixture may sometimes reversely return in accordance with the downward stroke of the piston 9 (blow-back). In this exemplary embodiment, when a piston valve is used, since a time lag until the intake port 5A is closed is large as compared with an arrangement using a reed valve, the amount of the reversely returning blow-back fuel tends to increase.

Accordingly, a mechanism for securely using the blow-back fuel without waste is adopted in the air supply device 2 in this exemplary embodiment. The air supply device 2 will be described in detail below.

The air supply device 2 includes an insulator 14 attached to the cylinder 5 of the engine body 1, a carburetor 15 attached to the insulator 14 and an air cleaner 16 attached to the carburetor 15.

The insulator 14 is made of synthetic resin and is heat insulative so as to restrain the transmission of the heat of the engine body 1 to the carburetor 15. The insulator 14 includes an insulator mixture passage 17 that is in communication with the intake port 5A of the cylinder 5 and an insulator air passage 18 that is in communication with the air port 5C of the cylinder 5.

The carburetor 15 used for a stratified scavenging engine includes a carburetor mixture passage 19 that is in communication with the insulator mixture passage 17 and a carburetor air passage 20 that is in communication with the insulator air passage 18. A main jet (not shown) is provided in the carburetor mixture passage 19. Fuel is drawn from the main jet due to the negative pressure inside the crankcase chamber 6. The fuel and intake air (fresh air from the air cleaner 16) are mixed to produce the air-fuel mixture.

Butterfly valves 21, 22 that are opened/closed in conjunction with an operation of an accelerator lever are provided in the respective passages 19, 20 of the carburetor 15. Intake flow rate in the carburetor mixture passage 19 and air flow rate in the carburetor air passage 20 are adjusted according to the opening degree of the butterfly valves 21, 22 in accordance with the drive condition of the engine.

Incidentally, a rotary valve may alternatively be used instead of the butterfly valves 21, 22 in this exemplary embodiment. The rotary valve may include a single cylindrical valve body penetrating the respective passages 19, 20. By rotating the single valve body in conjunction with the accelerator lever, the flow rate in the respective passages 19, 20 can be adjusted.

The air cleaner 16 includes a case 23 attached to the carburetor 15, a cover 24 attached to the case 23 and a filter element (not shown) disposed in the case and held against the cover 24.

The case 23 includes a mixture-side opening 25 that is in communication with the carburetor mixture passage of the carburetor 15 and an air-side opening 26 that is in communication with the carburetor air passage 20. The fresh air passing through the filter element is supplied to both of the openings 25, 26. The intake air (fresh air drawn through the mixture-side opening 25) is, as described above, mixed with the fuel in the carburetor mixture passage 19 to be delivered toward the intake port 5A as the air-fuel mixture. The fresh air drawn through the air-side opening 26 is directly supplied toward the air port 5C via the carburetor air passage 20 and the insulator air passage 18.

Further, a preventive plate 27 for trapping the blow-back fuel and preventing the blow-back fuel from being blown to the filter element is attached to the case 23 at a position opposing the mixture-side opening 25. The preventive plate 27 is a metal plate member that is sized not to impede the inhalation of the intake air sucked through the mixture-side opening 25. A choke plate may be advanceably and retractably provided between the preventive plate 27 and the mixture-side opening 25 to open/close the respective openings 25 and 26 as necessary. The choke plate is not illustrated herein.

A trap 28 for trapping the blow-back fuel projects from the preventive plate 27 toward the mixture-side opening 25. The blow-back fuel trapped by the trap 28 is again sucked together with the intake air toward the carburetor 15 to be used for producing the air-fuel mixture. However, the above-described preventive plate 27 is provided as necessary and may be omitted.

Incidentally, even in this exemplary embodiment having the preventive plate 27, it is difficult to completely trap the blow-back fuel by the preventive plate 27. The untrapped blow-back fuel drips downward on account of gravity to be accumulated at an accumulating portion 29 provided on a bottom side of the case 23. In the air supply device 2 of this exemplary embodiment, the blow-back fuel accumulated at the accumulating portion 29 can be utilized.

A through hole 30 that communicates the inside with an outside of the case 23 is provided on the bottom side of the case 23 that provides the accumulating portion 29. A base end of a pipe 31 made of a resin that is resistant to degradation against fuel is inserted from the outside into the through hole 30 to be connected to the accumulating portion 29. A distal end of the pipe 31 is inserted into a through hole 32 provided in the crankcase 4 to be connected with the crankcase chamber 6. Thus, the pipe 31 directly communicates the accumulating portion 29 with the crankcase chamber 6.

The connection between the pipe 31 and the respective through holes 30, 32 are sealed by a seal 33. The reference numeral 34 in FIG. 1 denotes an insulating material covering a middle part of the pipe 31. The area covered by the insulating material 34 may be determined so as to protect the pipe 31 from a heated portion of the engine body 1 considering an installation path of the pipe 31 and is not limited to the illustrated area.

The pipe 31 provides an auxiliary passage for delivering the blow-back fuel from the accumulating portion 29 to the inside of the crankcase chamber 6. The blow-back fuel accumulated at the accumulating portion 29 is sucked through the pipe 31 toward the crankcase chamber 6 with a lower pressure due to a pressure difference caused between the accumulating portion 29 and the crankcase chamber 6.

At this time, since the fuel amount sucked as the blow-back fuel is small as compared with the fuel amount flowing from the intake port 5A to the inside of the crankcase chamber 6, the engine performance is not greatly affected by adding the blow-back fuel.

Further, the inner diameter of the pipe 31 is sufficiently small and an opening area of the pipe 31 opened to the inside of the crankcase chamber 6 is also small. Accordingly, even when the stroke of the piston 9 turns downward, the air-fuel mixture in the crankcase chamber 6 scarcely enter into the pipe 31 and thus scarcely returns to the accumulating portion 29.

The above-described exemplary embodiment provides the following advantages.

The air supply device 2 is provided with the auxiliary passage in the form of the pipe 31 for communicating the accumulating portion 29 provided inside the case 23 of the air cleaner 16 and the crankcase chamber 6. Accordingly, even in an engine using a piston valve, the blow-back fuel can be sucked to the engine body 1 by the simply-structured pipe 31 without providing a complicated structure on the piston 9 and the cylinder 5.

Further, since the blow-back fuel accumulated at the accumulating portion 29 is securely used, less amount of blow-back fuel is to be trapped by the preventive plate 27. Thus, no large preventive plate 27 is necessary and the preventive plate 27 may be totally omitted as necessary. Accordingly, the increase in the intake resistance by the preventive plate 27 can be prevented and the engine performance can be favorably maintained.

### Second Exemplary Embodiment

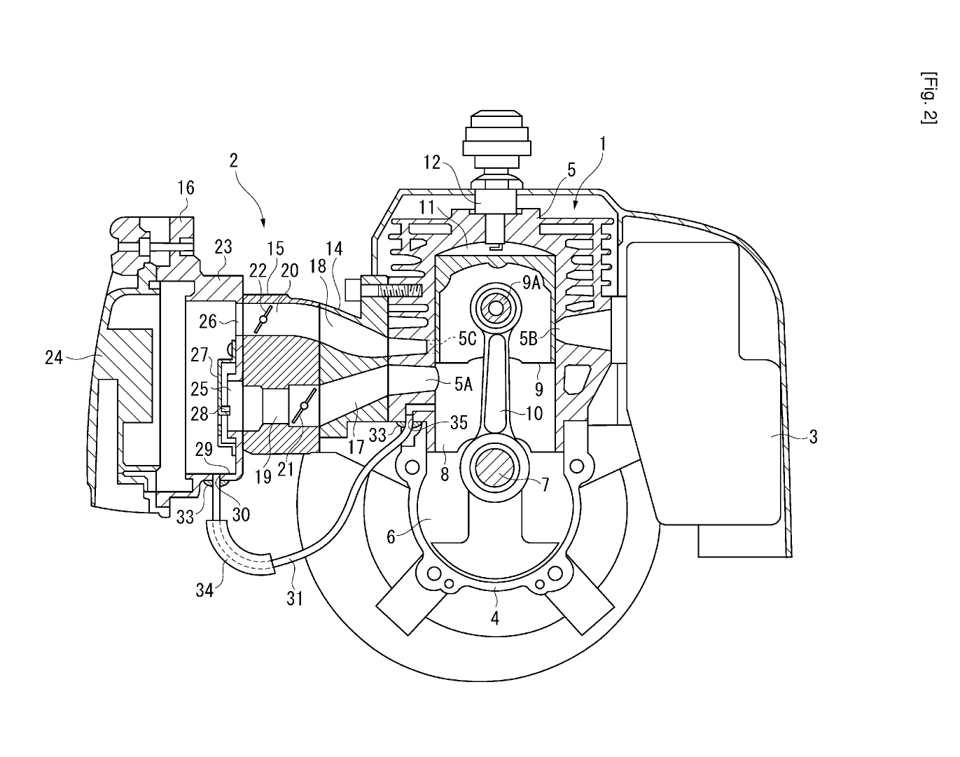

FIG. 2 shows a second exemplary embodiment of the invention. In this exemplary embodiment, a distal end of the pipe 31 is inserted into a through hole 35 provided in the cylinder 5 to be connected with the cylinder chamber 8. The through hole 35 is bent within the cylinder wall to communicate the inside with the outside of the cylinder chamber 8 at a lower part of the piston 9. Incidentally, the through hole 35 may be provided at a position opened and closed during a stroke of the piston 9 or at a position constantly opened. Further, the through hole 35 may extend horizontally and linearly at a portion at which the cylinder 5 and the crankcase 4 are overlapped so that the through hole 35 penetrates both of the cylinder 5 and the crankcase 4.

The blow-back fuel accumulated at the accumulating portion 29 of the air cleaner 16 can also be sucked into the crankcase chamber 6 through the cylinder chamber 8 in this exemplary embodiment, thereby attaining an object of the invention.

### Third Exemplary Embodiment

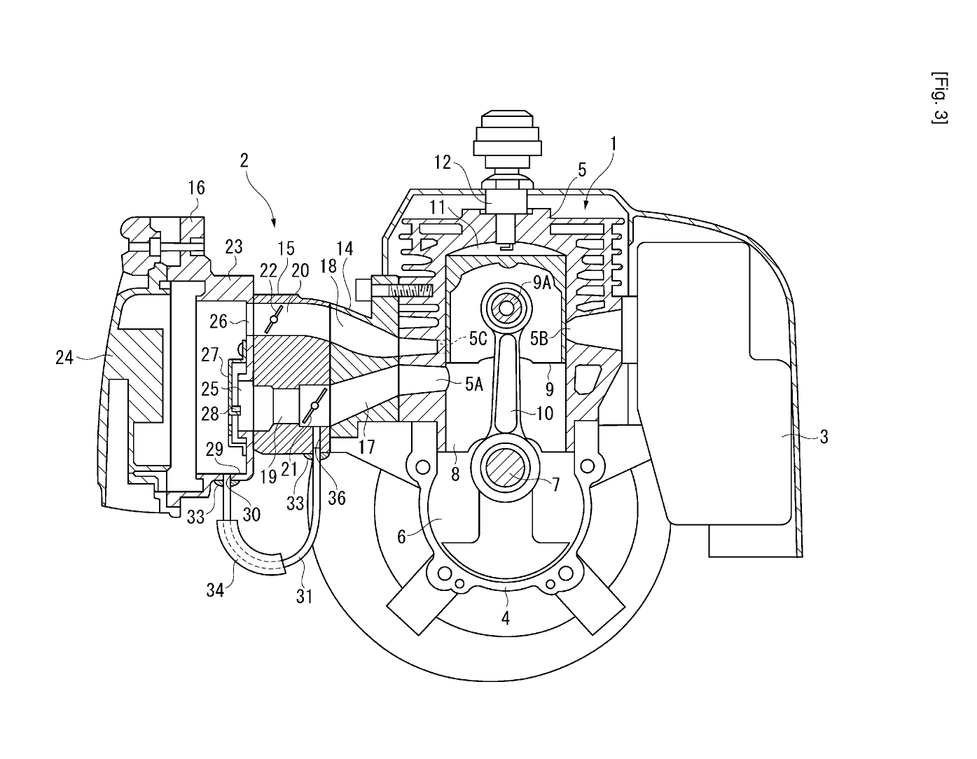

FIG. 3 shows a third exemplary embodiment of the invention. In this exemplary embodiment, a distal end of the pipe 31 is inserted into a through hole 36 provided at a lower part of the carburetor 15 to be connected with the carburetor mixture passage 19. The through hole 36 is vertically situated so as to communicate the carburetor mixture passage 19 with the outside. However, the lower side of the carburetor 15 is often occupied by a pump mechanism for sucking the fuel from the fuel tank, so that it is sometimes difficult to provide the through hole 36. In this case, the through hole 36 may be provided on a lateral portion of the carburetor 15.

This exemplary embodiment also allows sucking of the blow-back fuel at the accumulating Portion 29 toward the carburetor mixture passage 19 and using the blow-back fuel without waste.

### Fourth Exemplary Embodiment

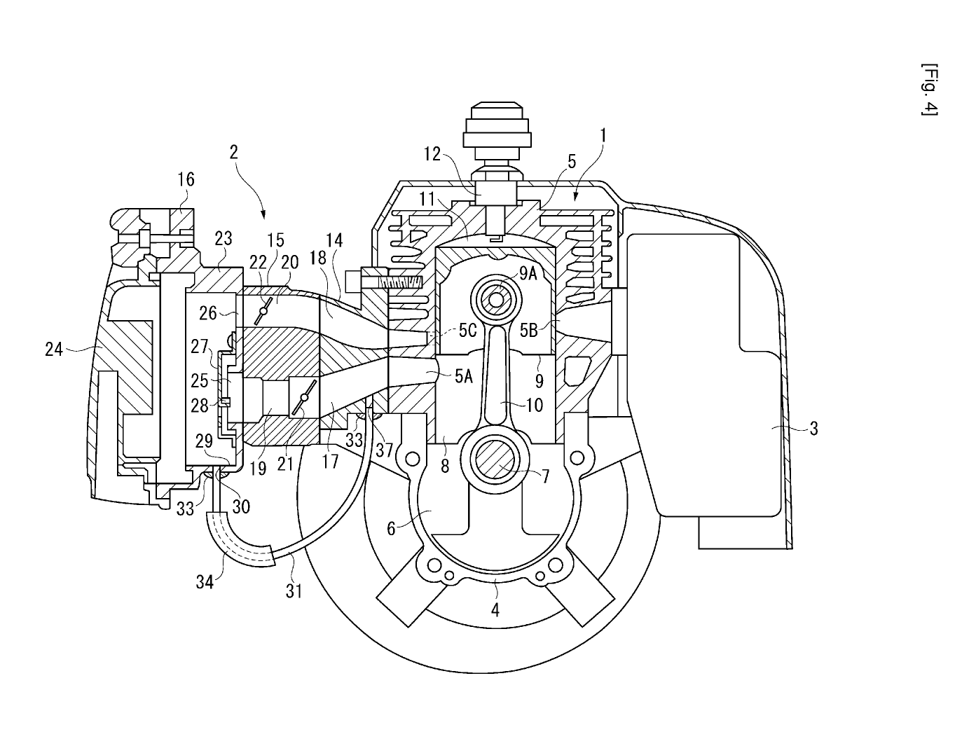

FIG. 4 shows a fourth exemplary embodiment of the invention. In this exemplary embodiment, a distal end of the pipe 31 is inserted into a through hole 37 provided at a lower part of the insulator 14 to be connected with the insulator mixture passage 17. The through hole 37 is a vertical hole that communicates the insulator mixture passage 17 with the outside. However, in the same manner as the third exemplary embodiment, when it is difficult to provide the through hole 37 on the lower side of the insulator 14 for some reason, the through hole 37 may be provided on a lateral or an upper portion of the insulator 14.

### Fifth Exemplary Embodiment

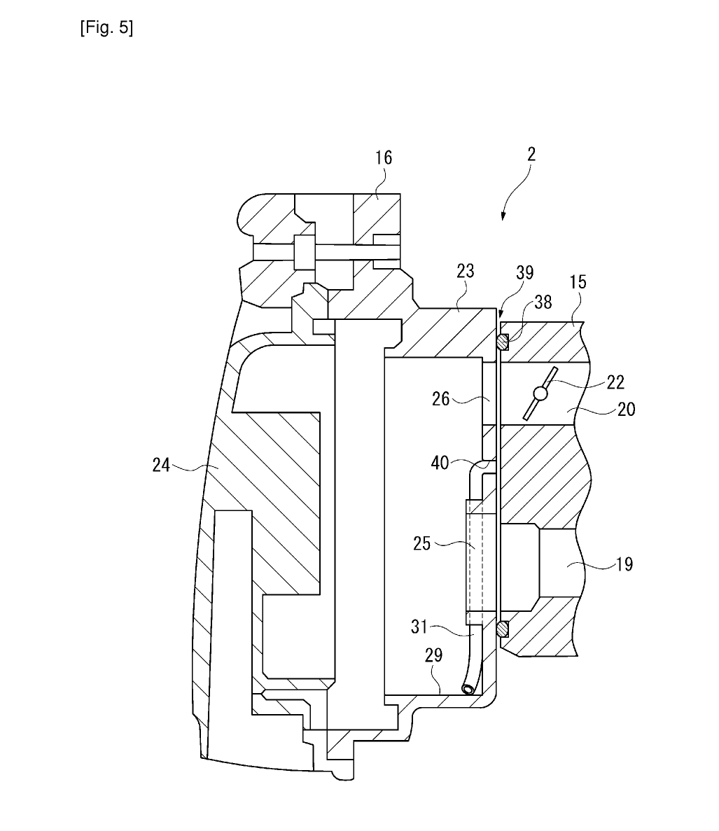

In the fifth exemplary embodiment of the invention shown in FIG. 5, the carburetor 15 and the case 23 of the air cleaner 16 are contacted via an O-ring 38 provided on the carburetor 15. A gap 39 is provided between the opposing surfaces of the carburetor 15 and the case 23. A through hole 40 that communicates an interior of the case 23 with the gap 39 is provided on a wall of the case 23 opposing against the carburetor 15. The through hole 40 is provided at an interior position surrounded by the O-ring 38. A base end of the pipe 31 (auxiliary passage) is located at the accumulating portion 29 and a distal end of the pipe 31 is inserted into the through hole 40 to be connected with the gap 39. Such a pipe 31 is disposed inside the case 23 and is fixed by a suitable fixing means such as an adhesive.

In this exemplary embodiment, since the gap 39 is in communication with the respective passages 19 and 20, a negative pressure is also applied to the gap 39. Accordingly, the blow-back fuel at the accumulating portion 29 is sucked into the gap 39 through the pipe 31 due to the pressure difference between the accumulating portion 29 and the gap 39. The sucked blow-back fuel flows into the respective passages 19, 20 to be supplied toward the engine body 1 to be used.

In this arrangement, since a part of the blow-back fuel is supplied to the air port 5C via the carburetor air passage 20 and the insulator air passage 18, the blow-back fuel is mixed in the lead air. However, since the mixed amount is small, even when the fuel is blown off together with the lead air during the scavenging process, the reduction in emission is not impeded. Incidentally, though the preventive plate 27 (FIGS. 1 to 4) is not illustrated in this exemplary embodiment, the preventive plate 27 may be provided as necessary, which also applies in the next sixth exemplary embodiment.

### Sixth Exemplary Embodiment

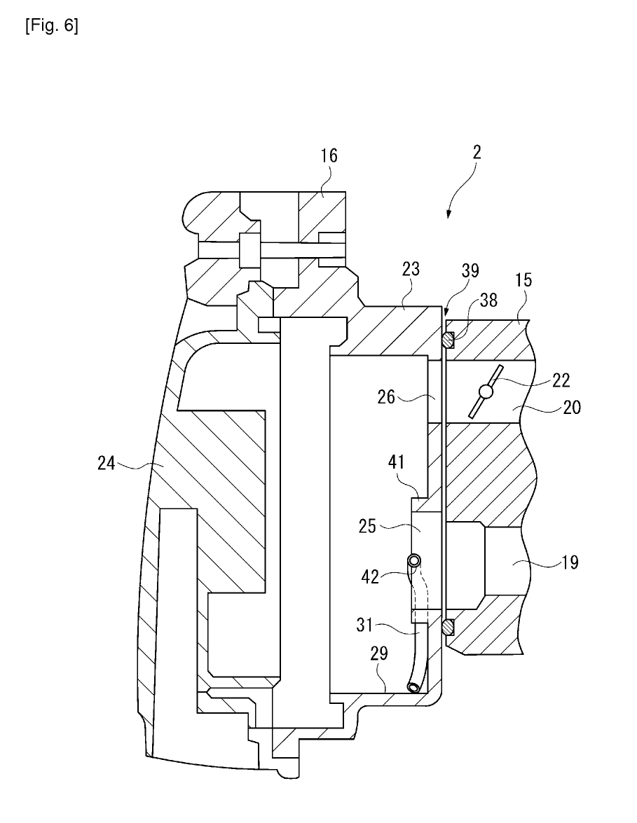

In the sixth exemplary embodiment shown in FIG. 6, a base end of the pipe 31 is located at the accumulating portion 29 and a distal end of the pipe 31 is inserted into and positioned at a cut 42 provided on a cylindrical rib 41 provided around the mixture-side opening 25 to be connected to the mixture-side opening 25. The pipe 31 is also fixed by a suitable fixing means such as an adhesive in this exemplary embodiment. However, when the position of the distal end of the pipe 31 can be sufficiently determined by fixing the pipe by an adhesive and the like, the cut 42 of the cylindrical rib 41 is not necessary.

The blow-back fuel is sucked through the pipe 31 due to the negative pressure applied from the carburetor mixture passage 19 to go out through the distal end of the pipe 31. The sucked blow-back fuel is sucked toward the carburetor mixture passage 19 after being mixed with the intake air to be supplied toward the engine body 1 after being mingled with the mixture produced in the carburetor mixture passage 19 to be used.

### Seventh Exemplary Embodiment

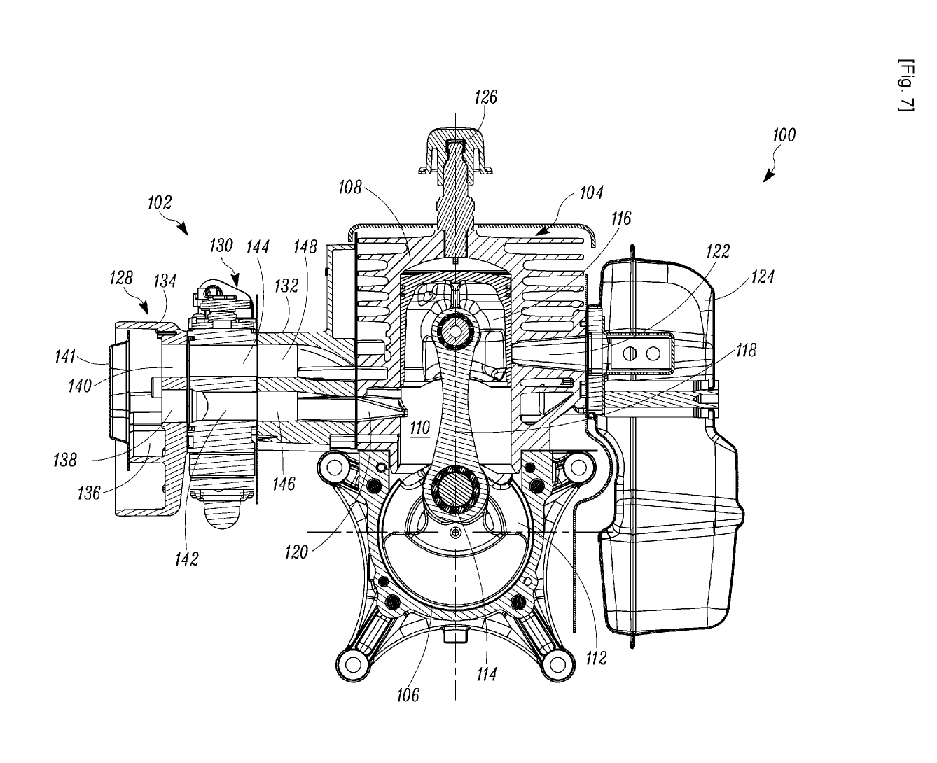

FIG. 7 illustrates a sectional view of a two-stroke combustion engine 100 including an air supply device 102, according to a seventh exemplary embodiment of the present invention. The two-stroke combustion engine 100 (hereinafter referred to as the “engine 100”) may be a stratified scavenging engine usable in various powered systems, such as, but not limited to chain saws, line trimmers, hedge trimmers, lawn mowers, outboard motors, and automobiles. In addition, any suitable size, shape or type of elements or materials could be used.

As shown in FIG. 7, the engine 100 includes a cylinder block 104 and a crankcase 106. The cylinder block 104 includes a single cylinder 108 with a cylinder chamber 110. However, in an alternative embodiment of the present invention, the cylinder block 104 may include two or more cylinders (not shown). The crankcase 106 includes a crankcase chamber 112 which encases a crankshaft 114. Typically, a piston 116 reciprocates inside the cylinder chamber 110 of the cylinder 108 and is connected to the crankshaft 114 via a connecting rod 118. Further, the cylinder 108 includes an intake port 120, an exhaust port 122 and one or more scavenging ports (not shown). Alternatively, the intake port 120 may be a part of the crankcase 106. An exhaust muffler 124 is also attached to the exhaust port 122 to reduce noise from exhaust gases. The scavenging ports may be located at different positions on the cylinder 108. In an embodiment of the present invention, the intake port 120 and/or the one or more scavenging ports may include reed valves (not shown) to regulate fluid flow. Further, one or more engine scavenging passages (not shown) may connect the crankcase chamber 112 with the inside of the cylinder 108. In an embodiment of the present invention, the scavenging ports may open into corresponding scavenging passages of the engine 100. Further, a spark plug 126 is also provided for igniting air-fuel mixture inside the cylinder 108.

As shown in FIG. 7, the air supply device 102 supplies an engine body with air-fuel mixture and scavenging air via the intake port 120 and the scavenging ports respectively. The air supply device 102 includes an air cleaner 128, a carburetor 130 and an insulator 132. The air cleaner 128 includes an air cleaner body 134 at least partly enclosing a chamber 136 with a mixture-side aperture 138 and an air-side aperture 140.

Further, the air cleaner 128 includes a metal preventive plate 141 and one or more filter elements (not shown). The one or more filter elements serve to trap particulate matter and/or absorb any liquid present in the ambient air before the air is introduced in the carburetor 130. The preventive plate 141 may be a preventive plate which is attached to the air cleaner body 134 by various means, such as, but not limited to, mechanical fasteners, welding, brazing, adhesives, or the like. The preventive plate 141 may substantially prevent blow-back fuel from flowing out of the chamber 136 toward the filter elements, thereby enabling blow-back fuel to flow back into the crankcase chamber 112 via the auxiliary passage described later. Further, the preventive plate 141 also substantially precludes clogging caused by blow-back fuel flowing into the filter elements.

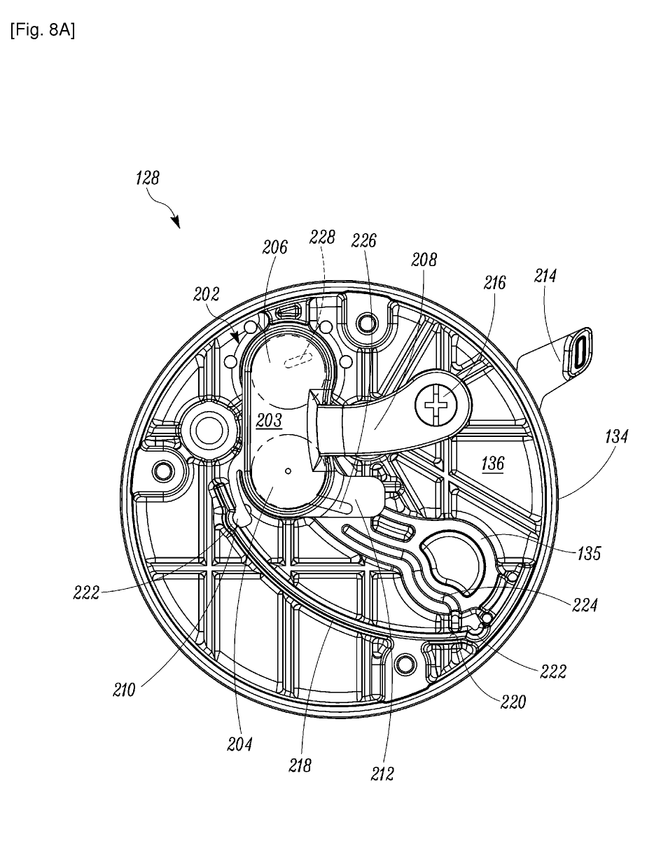

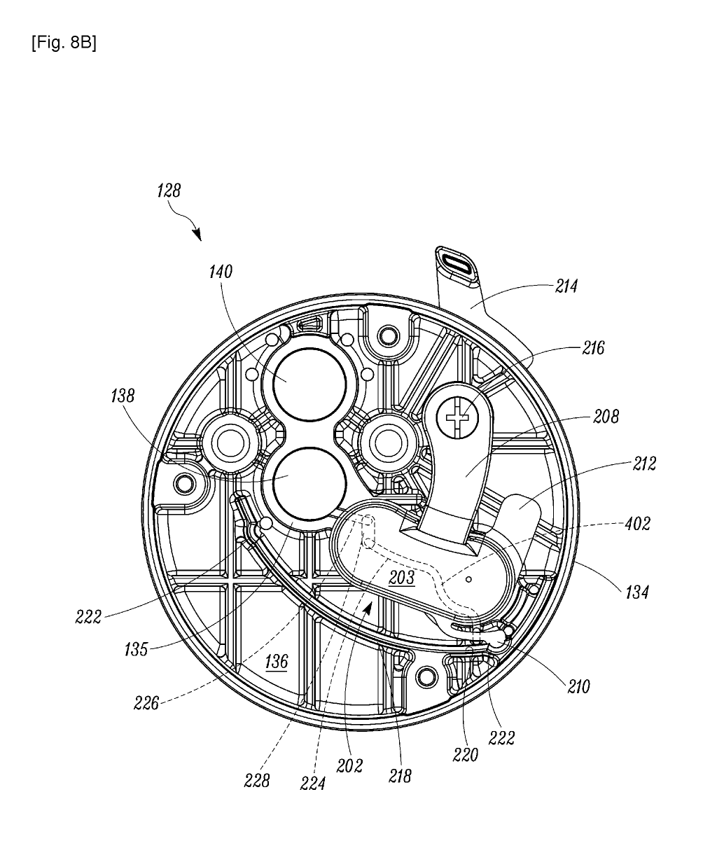

Further, a cover (not shown) may be attached to the air cleaner body 134. The air cleaner 128 also includes a choke plate (not shown) movable between an open position and a closed position. The choke plate may be provided to substantially prevent a flow of air through the mixture-side aperture 138 and/or the air-side aperture 140 in a closed position. Moreover, the air cleaner 128 includes at least one auxiliary passage (not shown) which at least partially connects a part of the chamber 136 to the mixture-side aperture 138 and/or the air-side aperture 140. The auxiliary passage is formed in the air cleaner body 134 as described with FIGS. 8A and 8B.

As shown in FIG. 7, the carburetor 130 includes a carburetor-side mixture passage 142 and a carburetor-side air passage 144. The mixture-side aperture 138 and the air-side aperture 140 of the air cleaner 128 are in connection with the carburetor-side mixture passage 142 and the carburetor-side air passage 144 respectively. Further, as shown in FIG. 7, the carburetor-side mixture passage 142 and the carburetor-side air passage 144 are connected to an insulator-side mixture passage 146 and an insulator-side air passage 148 respectively of the insulator 132. Further, the insulator-side mixture passage 146 and the insulator-side air passage 148 are connected to the intake port 120 and the scavenging ports respectively of the engine body.

During an operation of the engine 100, at least a portion of blow-back fuel accumulates in a accumulating portion (described later) of the chamber 136 due to gravity, one or more guiding portions (described later), the preventive plate 141, or a combination of these. At least a portion of blow-back fuel then flows back to the crankcase chamber 112 via the auxiliary passage due to a difference between a pressure inside the chamber 136 of the air cleaner 128 and a pressure inside the crankcase chamber 112. However, blow-back fuel may flow back to any other part of the engine 100 (For example, the cylinder 108) at a pressure different from a pressure inside the chamber 136 of the air cleaner 128.

It may be apparent to a person who is ordinarily skilled in the art that the details of the engine 100 and the air supply device 102 described above are for illustration purposes only, and the engine 100 and the air supply device 102 may be of different configurations without deviating from the scope of the present invention. For example, in various embodiments of the present invention, the engine 100 may not utilize scavenging air to expel exhaust gases. In such case, the scavenging ports, the insulator-side air passage 148, the carburetor-side air passage 144, and the air-side aperture 140 of the air cleaner 128 may not be present. Alternatively, in other embodiments of the present invention, multiple scavenging air flow paths from the air cleaner 128 to the engine 100 may be present. In some embodiments of the present invention, a single flow path of scavenging air may branch off into two or more paths.

FIGS. 8A and 8B illustrate the air cleaner 128 when the preventive plate 141 is removed, as a seventh exemplary embodiment of the present invention. Further, FIGS. 8A and 8B illustrate the choke plate 202 in the closed position and the open position respectively. As shown in FIGS. 8A and 8B, the choke plate 202 is shaped in a plate. The choke plate 202 has a first surface (not shown in the FIGS. 8A and 8B) that faces the mixture-side aperture 138 and the air-side aperture 140 in the closed position. A second surface 203 is opposite to the first surface. Further, the choke plate 202 includes a first blocking portion 204, a second blocking potion 206, an actuating portion 208, a retaining portion 210 and an extending portion 212. The first blocking portion 204 and the second blocking portion 206 are configured to substantially prevent air flow through the mixture-side aperture 138 and the air-side aperture 140 respectively in the closed position. Further, the actuating portion 208 is connected to an actuating lever 214 with a fastening member 216. The fastening member 216 may be a threaded screw which mates with a corresponding threaded part (not shown) of the actuating lever 214. However, in alternative embodiments of the present invention, the actuating portion 208 and the actuating lever 214 may be attached by adhesives or may be integrally formed. As shown in FIGS. 8A and 8B, the actuating portion 208 and the actuating lever 214 together pivot about an axis substantially perpendicular to the plane of the paper. Thus, the choke plate 202 moves between the closed position and the open position due to pivoting of the actuating lever 214. The actuating lever 214 may be manually or automatically actuated within the scope of the present invention. It may be apparent to a person ordinarily skilled in the art that the choke plate 202 may be of any other shape of configuration without departing from the scope of the present invention. Further, the choke plate 202 may be actuated in other ways, for example, but not limited to, electromagnetically, pneumatically, or the like.

As shown in FIGS. 8A and 8B, the air cleaner body 134 includes a guiding portion 218 which facilitates a flow of blow-back fuel to a accumulating portion 220 of the chamber 136 due to gravity. The accumulating portion 220 is located at a lower region of the chamber 136 and more specifically, located adjacent to a lower portion of the guiding portion 218. However, the accumulating portion 220 may be any other region or part of the air cleaner 128 within the scope of the invention. As shown in FIGS. 8A and 8B, the guiding portion 218 is a curved rib formed in the body 134 and protruding in the chamber 136. In other words, by locating an upper end of the curved rib near the mixture-side aperture 138 and a lower end of the curved rib near the accumulating portion 220, the blow-back fuel from the mixture-side aperture 138 can be guided to the accumulating portion 220. The guiding portion 218 may be part of any other component of the air cleaner 128 within the scope of the present invention. Further, the guiding portion 218 includes locking portions 222 of which an upper end corresponds to the open position and a lower end corresponds to the closed position. The retaining portion 210 of the choke plate 202 is engaged with the locking portions 222. Moreover, the retaining portion 210 may be resilient in nature such that the retaining portion 210 is properly engaged with the locking portions 222. This may substantially prevent the choke plate 202 from being displaced from the open position or the close position due to vibration of the engine 100 or any other component. Displacement of the choke plate 202 may interfere with an operation of the engine 100. For example, the choke plate 202 may get displaced from the open position to the closed position, thereby cutting off air supply to the engine 100 and prematurely shutting down the engine 100. It may be apparent to a person skilled in the art that the choke plate 202 may be retained in the open and closed positions by any other means, for example, one or more springs, electromagnetic system, or the like.

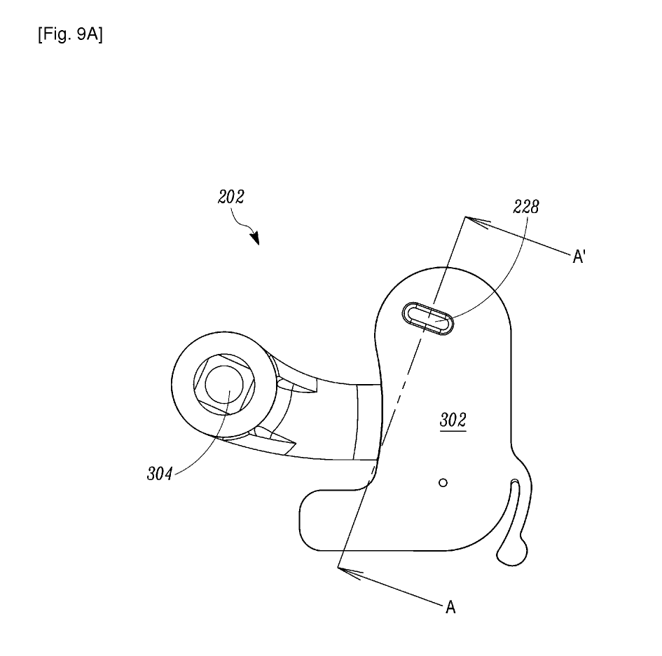

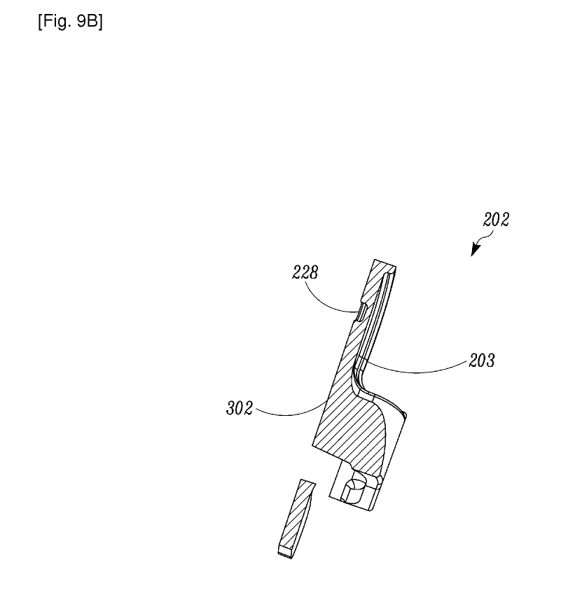

As shown in FIGS. 8A and 8B, the air cleaner body 134 includes a first passage groove 224 and a second passage groove 226. The first passage groove 224 and the second passage groove 226 together form a part of an auxiliary passage 402. The first passage groove 224 is in communication with the accumulating portion 220 of the chamber 136. Further, the second passage groove 226 is in communication with the mixture-side aperture 138. The first passage groove 224 and the second passage groove 226 are grooves integrally formed in the air cleaner body 134. In the closed position of the choke plate 202, the extending portion 212 of the choke plate 202 at least substantially seals the second passage groove 226, thereby preventing any fluid flow through the mixture-side aperture 138. The extending portion 212 may also include a peripheral lining (not shown) for proper sealing. Moreover, in the closed position, the first passage groove 224 and the second passage groove 226 are not in communication which substantially precludes flow of fluid through the mixture-side aperture 138 via the first passage groove 224 and the second passage groove 226. However, in the open position of the choke plate 202, a connecting groove 228 on the first surface 302 (FIG. 9A) of the choke plate 202 connects the first passage groove 224 and the second passage groove 226, thereby enabling blow-back fuel to flow from the accumulating portion 220 to the mixture-side aperture 138. The connecting groove 228 provides an auxiliary passage formation portion on the first surface 302 of the choke plate 202 to form a part of the auxiliary passage 402 (shown in FIGS. 9A and 9B).

In other words, the auxiliary passage 402 is formed in a single continuous cylinder with the first passage groove 224, the second passage groove 226, the connecting groove 228, the first surface 302 facing the first and second passage grooves 224 and 226, and a surface 135 of the air cleaner body 134 facing the connecting groove 228. By closing the grooves 224, 226 and 228 by the surfaces 135 and 302, only both ends of the auxiliary passage 402 are open. Accordingly, in this exemplary embodiment, the first surface 302 of the choke plate 202 covering the first and second passage grooves 224 and 226 also forms a part of the auxiliary passage 402 to provide the auxiliary passage formation portion.

It may be apparent to a person ordinarily skilled in the art that the shapes and relative sizes of the first passage groove 224, the second passage groove 226 and the connecting groove 228 are for illustrative purposes only. The first passage groove 224, the second passage groove 226 and the connecting groove 228 may be of any shape and relative size within the scope of the present invention. For example, the first passage groove 224 may be linear in shape instead of a curvilinear shape shown in FIGS. 8A and 8B. Further, the first passage groove 224 may have an effective flow length lower than that of the second passage groove 226.

FIG. 9A illustrates the choke plate 202 with the first surface 302, according to the seventh exemplary embodiment of the present invention. As shown in FIG. 9A, the first surface 302 of the choke plate 202 includes the connecting groove 228. Further, the choke plate 202 includes an aperture 304 through which the fastening member 216 passes.

FIG. 9B illustrates a sectional view of the choke plate 202 along an axis A-A′ in FIG. 9A. As shown in FIG. 9B, the connecting groove 228 is a concave groove on the first surface 302 of the choke plate 202. It may be apparent to a person substantially skilled in the art that the connecting groove 228 may have any cross-section within the scope of the present invention, for example, a semi-circle, an open polygon, or the like.

### Eighth Exemplary Embodiment

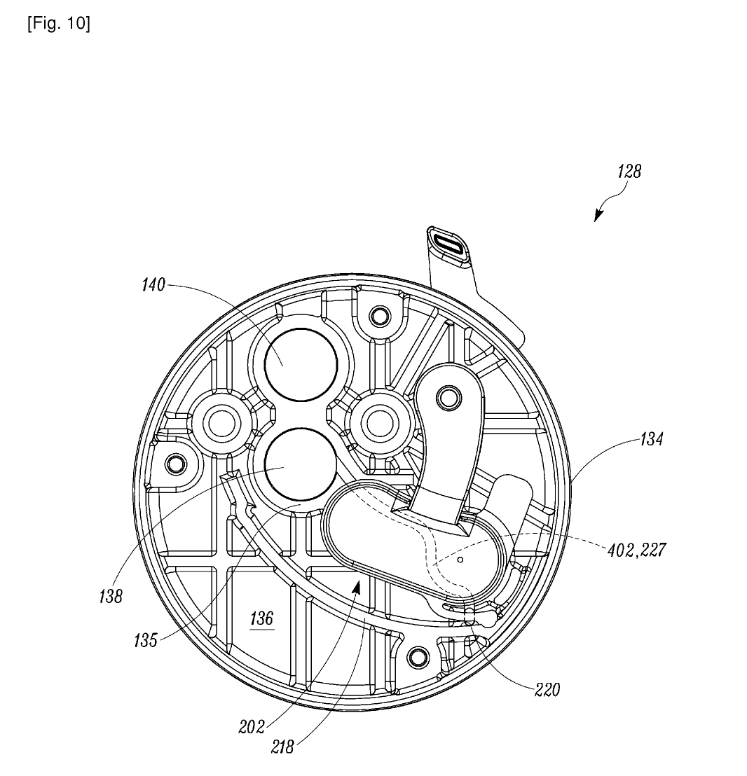

FIG. 10 illustrates the air cleaner 128 in an eighth exemplary embodiment of the present invention. As shown in FIG. 10, the air cleaner body 134 includes a single auxiliary passage 402 that connects the accumulating portion 220 with the mixture-side aperture 138. Further, the auxiliary passage 402 is formed with a passage groove 227 integrally formed on the surface 135 of the air cleaner body 134 and a part of the first surface 302 (see FIG. 9A) of the choke plate 202 covering the passage groove 227. Alternatively, the auxiliary passage 402 may be a separate conduit attached to the second surface 203 (see FIG. 9B) of the choke plate 202 by various means, such as, adhesives, mechanical fasteners, welding, or the like. Moreover, the auxiliary passage 402 may of any shape within the scope of the present invention.

### Ninth Exemplary Embodiment

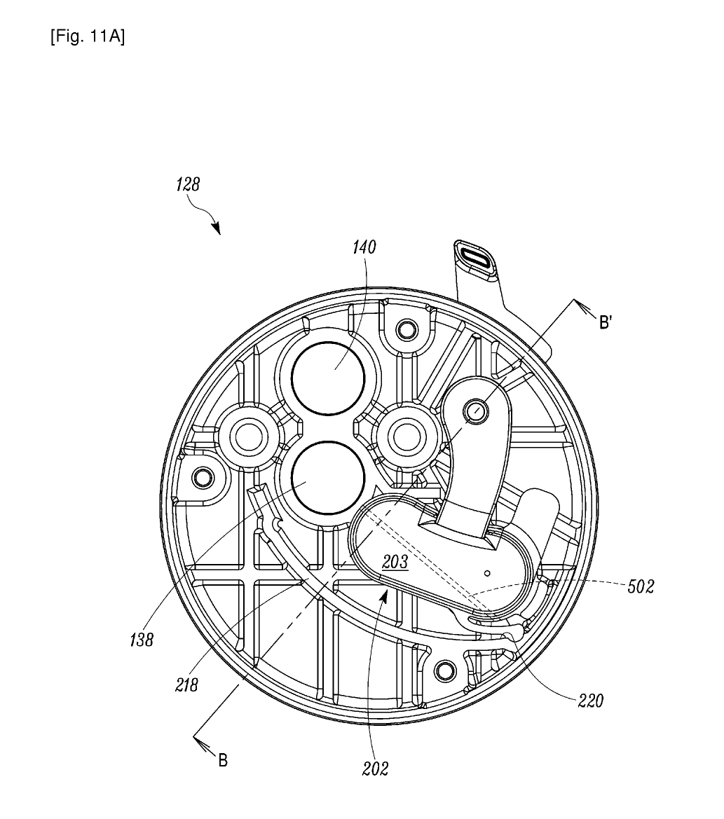

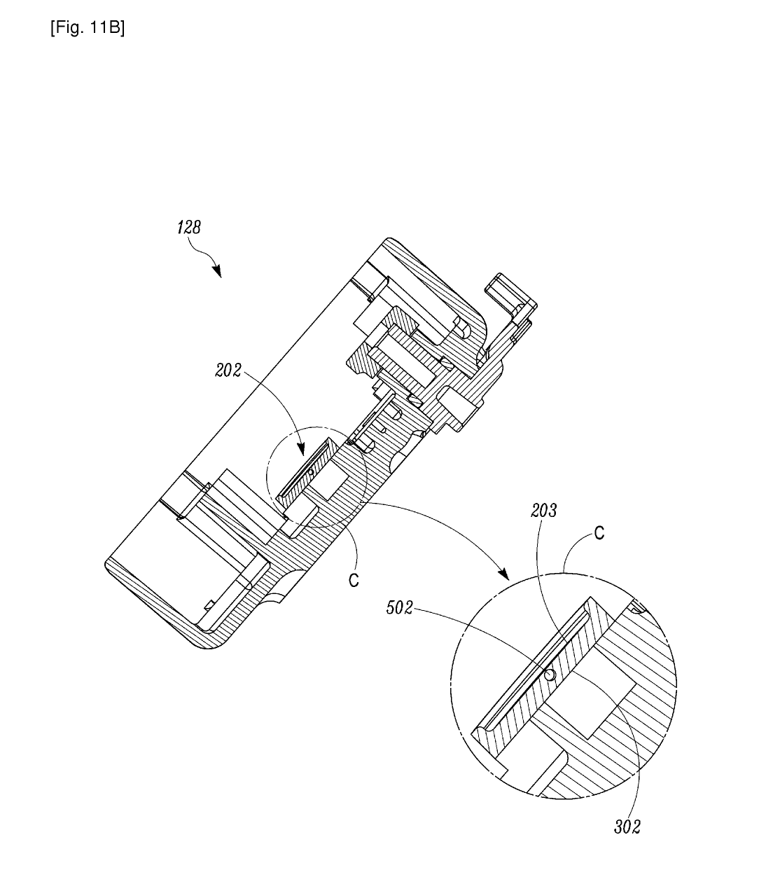

FIG. 11A illustrates the air cleaner 128 in a ninth exemplary embodiment of the present invention. As shown in FIG. 11A, the choke plate 202 includes an auxiliary passage 502. The auxiliary passage 502 is located between the first surface 302 and the second surface 203 of the choke plate 202 and penetrates a thick portion thereof (shown in detail in FIG. 11B). The auxiliary passage 502 connects the accumulating portion 220 to the mixture-side aperture 138 in the open position of the choke plate 202. As shown in FIG. 11A, the auxiliary passage 502 has a linear shape. However, the auxiliary passage 502 may have any shape within the scope of the present invention.

FIG. 11B illustrates a sectional view of the air cleaner 128 along an axis B-B′ in FIG. 11A. As shown in a detailed view C of the choke plate 202, the auxiliary passage 502 is located proximate to the second surface 203 between the first surface 302 and the second surface 203 of the choke plate 202. Further, the auxiliary passage 502 is shaped in a conduit with a substantially elliptical cross-section. However, the auxiliary passage 502 may have any other cross-section, for example, but not limited to, circular, oval, polygonal, or the like. Moreover, the auxiliary passage 502 may be a groove provided on the first surface 302 of the choke plate 202 and may also be a separate member attached to the second surface 203 of the choke plate 202.

Incidentally, it should be understood that the scope of the invention is not limited to the above-described embodiments but includes modifications as long as an object of the invention can be achieved.

For instance, though the engine of the respective exemplary embodiments is a stratified scavenging engine, the air supply device according to the invention can be applied to a conventional (i.e. not stratified scavenging) two-stroke engine.

Though the carburetor 15 has the integrated carburetor air passage 20, the air passage may be provided by a separate pipe member independent of the carburetor and may be disposed independently of the carburetor. In this case, the carburetor may be provided by the one used for a conventional two-stroke engine.

Though the single pipe 31 is employed for providing the auxiliary passage in the respective exemplary embodiments, a plurality of pipes may alternatively be employed to provide a plurality of auxiliary passages. In this case, though all of the base ends of the plurality of pipes are in communication with the accumulating portion 29 of the air cleaner 16, it is not necessary for all of the distal ends thereof to be in communication with the same location but the distal ends may be in communication with different locations. For instance, the distal end of one pipe may be connected to the crankcase chamber 6 and the other distal end of the pipe may be connected to the cylinder chamber 8.

Though the pipe 31 is disposed inside the air cleaner 16 in the fifth and sixth exemplary embodiments, a pipe-shaped auxiliary passage may alternatively be, for instance, integrally molded on an inner surface of the case 23 of the air cleaner 16 to eliminate the use of the pipe 31.

### INDUSTRIAL APPLICABILITY

The air supply device according to the invention is suitably applied to a two-stroke engine used for portable operating machine such as a mower and a chain saw.

### REFERENCE SIGNS LIST

1 . . . engine body
2 . . . air supply device
5A . . . intake port
6 . . . crankcase chamber
8 . . . cylinder chamber
14 . . . insulator
15 . . . carburetor
16 . . . air cleaner
17 . . . insulator mixture passage
19 . . . carburetor mixture passage
25 . . . mixture-side opening
29 . . . accumulating portion
31 . . . pipe as an auxiliary passage
34 . . . insulating material
39 . . . gap
100 . . . two-stroke combustion engine
102 . . . air supply device
104 . . . cylinder block
106 . . . crankcase
108 . . . cylinder
110 . . . cylinder chamber
112 . . . crankcase chamber
114 . . . crankshaft
116 . . . piston
118 . . . connecting rod
120 . . . intake port
122 . . . exhaust port
124 . . . exhaust muffler
126 . . . spark plug
128 . . . air cleaner
130 . . . carburetor
132 . . . insulator
134 . . . air cleaner body
135 . . . surface
136 . . . chamber of the air cleaner
138 . . . mixture-side aperture
140 . . . air-side aperture
141 . . . preventive plate
142 . . . carburetor-side mixture passage
144 . . . carburetor-side air passage
146 . . . insulator-side mixture passage
148 . . . insulator-side air passage
202 . . . choke plate
203 . . . second surface
204 . . . first blocking portion
206 . . . second blocking portion
208 . . . actuating portion
210 . . . retaining portion
212 . . . extending portion
214 . . . actuating lever
216 . . . fastening member
218 . . . guiding portion
220 . . . accumulating portion
222 . . . locking portions
224 . . . first passage groove
226 . . . second passage groove
227 . . . passage groove
228 . . . connecting groove
302 . . . first surface
304 . . . aperture
402 . . . auxiliary passage
502 . . . auxiliary passage

1. An air supply device used for a two-stroke engine, comprising:
an insulator having an insulator mixture passage that is in communication with an intake port provided on an engine body of the two-stroke engine, the insulator being attached to the engine body;
a carburetor having a carburetor mixture passage that is in communication with the insulator mixture passage, the carburetor being attached to the insulator; and
an air cleaner having a mixture-side opening that is in communication with the carburetor mixture passage, the air cleaner being attached to the carburetor, characterized by:
an accumulating portion provided inside the air cleaner, the accumulating portion accumulating a blow-back fuel returned from the mixture-side opening; and
an auxiliary passage having a base end connected to the accumulating portion and a distal end connected to a portion affected by a pressure fluctuation inside a crankcase chamber provided to the engine body.

2. The air supply device according to claim 1, wherein the distal end of the auxiliary passage is connected to the crankcase chamber itself.

3. The air supply device according to claim 1, wherein the distal end of the auxiliary passage is connected to a cylinder chamber provided in the engine body.

4. The air supply device according to claim 1, wherein the distal end of the auxiliary passage is connected to the carburetor mixture passage of the carburetor.

5. The air supply device according to claim 1, wherein the distal end of the auxiliary passage is connected to the insulator mixture passage of the insulator.

6. The air supply device according to claim 1, wherein the distal end of the auxiliary passage is connected to a gap provided between opposing surfaces of the carburetor and the air cleaner, and the gap is in communication with the carburetor mixture passage.

7. The air supply device according to claim 1, wherein the distal end of the auxiliary passage is connected to the mixture-side opening.

8. The air supply device according to claim 6 or 7, wherein the auxiliary passage is provided inside the air cleaner.

9. The air supply device according to claim 8, further comprising:
a choke plate capable of opening/closing the mixture-side aperture, wherein the choke plate is provided with an auxiliary passage formation portion that forms at least a part of the auxiliary passage when the choke plate is positioned to open the mixture-side aperture.

10. The air supply device according to claim 9, wherein the auxiliary passage includes:
a first passage groove of which one end is communicated with the accumulating portion, the first passage groove being provided on a surface of the air cleaner body;
a second passage groove of which one end is communicated with the mixture-side aperture, the second passage groove being provided on the surface of the air cleaner body; and
the auxiliary passage formation portion, wherein the auxiliary passage formation portion is provided by a part of a surface of the choke plate that faces and covers the first and second passage grooves, and a connecting groove that communicates the other ends of the first and second passage grooves with each other.

11. The air supply device according to claim 10, wherein the second passage groove is closed by the choke plate when the choke plate is positioned to close the mixture-side aperture.

12. The air supply device according to claim 9, wherein the auxiliary passage includes:
a connecting groove of which one end is communicated with a accumulating portion and the other end is communicated with the mixture-side aperture; and the auxiliary passage formation portion, wherein the auxiliary passage formation portion is a part of a surface of the choke plate that faces and covers the connecting groove.

13. The air supply device according to claim 9, wherein the auxiliary passage is provided by a conduit that penetrates a thick portion of the choke plate to communicate the accumulating portion and the mixture-side aperture with each other.

14. The air supply device according to claim 9, wherein the air cleaner body includes a pair of lock portions corresponding to the open/closed positions of the mixture-side aperture by the choke plate, and the choke plate includes a retaining portion that is engaged with the lock portion.

15. The air supply device according to claim 14, wherein the pair of lock portions is provided near an end of a curved rib along an open/closed trajectory of the choke plate, and the curved rib serves as a guiding portion that guides the blow-back fuel from the mixture-side aperture toward the accumulating portion, an upper end of the curved rib being positioned near the mixture-side aperture and a lower end of the curved rib being positioned near the accumulating portion.

16. The air supply device according to claim 1, wherein the auxiliary passage is provided by a pipe.

17. The air supply device according to claim 1, wherein at least a part of the auxiliary passage is covered by an insulating material.

18. The air supply device according to claim 1, wherein the accumulating portion is provided at a position at which the blow-back fuel from the mixture-side opening drips to be accumulated.

19. The air supply device according to claim 1, wherein the air supply device is applied to a piston-valve two stroke engine in which the intake port is opened and closed by a piston.
